(19) United States
(12) Patent Application Publication
(10) Pub. No.: US 2015/0036826 A1
(43) Pub. Date: Feb. 5, 2015

(54) STEREO EXPANDER METHOD

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/273,471

(22) Filed: May 8, 2014

Related U.S. Application Data
(60) Provisional application No. 61/821,072, filed on May 8, 2013.

(51) Int. Cl. H04S 7/00

(52) U.S. Cl. CPC H04S 7/30
USPC 381/1

(57) ABSTRACT

An audio enhancement technique comprising an audio source, processing the audio source by the following modules, a low pass filter with dynamic offset, an envelope controlled bandpass filter, a high pass filter; and adding an amount of dynamic synthesized sub bass to the audio. The processed audio signals are combined in a summing mixer with the audio source to create an audio out signal. Audio out is sent to a block that splits, processes and combines the stereo stream into several different versions that are fed into the Stereo Bus A. The Stereo Bus is fed to a Compare Block that adjusts the amplitude of the original and processed audio by averaging.

### CROSS-REFERENCE TO RELATED PATENT APPLICATIONS

Embodiments of the present invention relate to U.S. Provisional Application Ser. No. 61/821,072, filed May 8, 2013, entitled “STEREO EXPANDER”, the contents of which are incorporated by reference herein and which is a basis for a claim of priority.

### BACKGROUND OF THE INVENTION

Today's audio, both analog and digital, is often dull and lifeless sounding. There are many forms of enhancement, such as EQ, Reverb, Delay, etc. which fail to give the user a good audio experience. The consumer has been forced to accept inferior quality as the norm.

A new stereo enhancement technique and process is required that addresses the above noted deficiencies of the conventional systems.

### SUMMARY OF THE INVENTION

The inventive MSPander process will allow the user to experience a fully dynamic and harmonic rich experience without the need for expensive equipment, as needed before. Whether using headphones, earbuds, or speakers, the MSPander will expand the range of these for an audio experience comperable to much larger and more expensive ones.

According to one embodiment, the invention is a combination of the App processor plus a sound field expander. Together these two modules make for a highly powerful and dynamic audio enhancement/processor. In one embodiment, the controls are the same as each individual process, but could be configured to have less by entering preset amounts for the controls that aren't exposed in a GUI.

### BRIEF DESCRIPTION OF THE DRAWINGS

FIG. 1 is a block diagram showing the inventive MSPander process according to an exemplary embodiment of the present invention.

FIG. 2 is a detailed diagram showing the various processing blocks and steps according to an exemplary embodiment of the present invention.

FIG. 3 is a representation of how the levels of Stereo Bus A and Stereo Output change relevant to each other according to an exemplary embodiment of the present invention.

### DETAILED DESCRIPTION OF THE PREFERRED EMBODIMENT(S)

Details of the present invention will now be discussed by reference to the drawings.

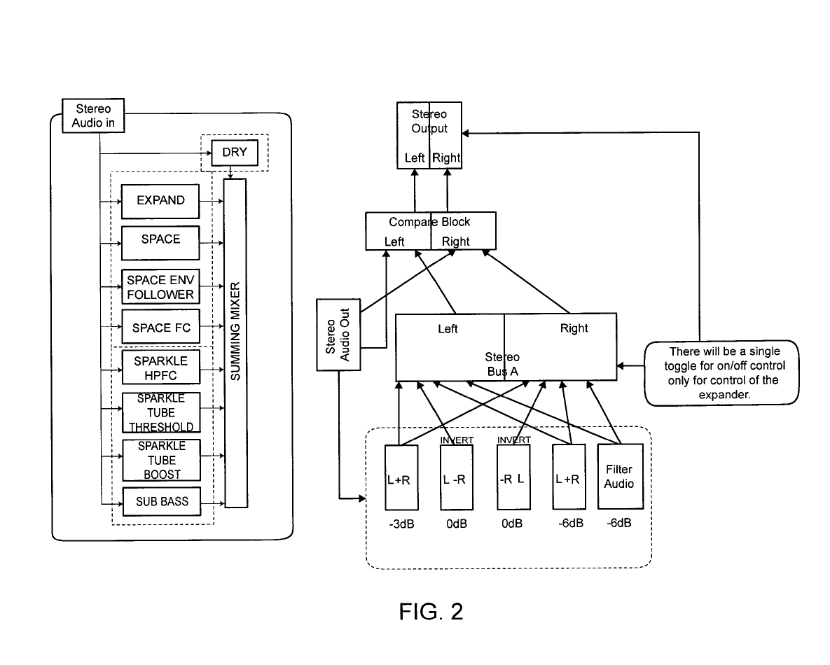

FIG. 2 shows a complete signal flow diagram according to an embodiment of the present invention. The audio goes through the complete “MAXD APP” process and then flows into the Sound Field Expander process. The values for the expander are indicated in the drawing. In this application, the expander will have only an “On/Off” button for control. There will be no user control other than that for the expander portion. Advantageously, the inventive process could be used for smart phone apps, audio playback devices, television, portable music systems, or any device where better audio quality is desired.

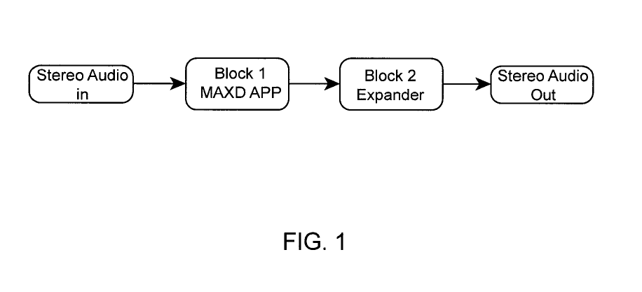

Referring to FIGS. 1 and 2, the initial audio signal is treated in four different ways in parallel and then combined with the original audio source in a mixer. The original audio signal is processed by EXPAND in FIG. 2. EXPAND is a low pass filter with dynamic offset. The frequency for the low pass filter is preferably about 40k to 20k hertz. In one embodiment, the frequency is about 2000 Hertz. The range for EXPAND is 0-1, with intervals of 0.1. EXPAND can be preset in the program.

The original audio signal is also processed by SPACE in FIG. 2, which depicts three blocks for SPACE. The top block “SPACE” is the output level for this block. The next block is the envelope follower modulation amount, and the last block is the frequency range for SPACE block. The SPACE is an envelope controlled bandpass filter. Preferably, the output amplitude for space ranges from about 0 to 3, such as about 1.8. The frequency range for SPACE preferably ranges from about 1000 to about 8000 Hertz. The settings for SPACE can also be preset,

The original audio signal is also processed by SPARKLE, shown in FIG. 2, which shows three blocks for SPARKLE. The top block is the output level for this block, the SPARKLE HPFC set HP filter frequency, and SPARKLE TUBE BOOST sets amount of tube simulator sound. SPARKLE is a high pass filter. The frequency for the high pass filter preferably ranges from about 4000 to about 10000 Hertz. In one embodiment, tube simulator is set in single digits from 1-5, with the threshold ranging from 0-1 in 0.1 intervals. The settings for SPARKLE can also be preset.

The original audio signal is also processed by SUB BASS shown in FIG. 2, which adds an amount of dynamic synthesized sub bass to the audio. The frequency of the sub bass is preferably about 120 Hz or less.

The four treated audio signals (EXPAND, SPACE, SPARKLE, SUB BASS) are combined in a summing mixer to produce an audio signal with improved quality.

The various processing modules will now be described in more detail.

EXPAND—is a 4 pole digital low pass filter with an envelope follower for dynamic offset (FIXED ENVELOPE FOLLOWER). This allows the output of the filter to be dynamically controlled so that the output level is equal to whatever the input is to this filter section. For example, if the level at the input is −6 dB, then the output will match that. Whenever there is a change at the input, the same change will occur at the output regardless of either positive or negative amounts. The frequency for this filter is preferably in the range of 20 to 20 k hertz, in other words it is full range. The purpose of this filter is to “warm up” or provide a fuller sound as audio that passes through it. The original sound passes through, and is added to the effected sound for its output. As with all filters used in the inventive software applicaiton, as the input amount increases or decreases (varies), so does the phase of this section. Preferably, all filters are of the Butterworth type.

SPACE—There are several components to this module. They are: SPACE—this amount is after the envelope follower and sets the final level of this module. This is the effected signal only, without the original. SPACE ENV FOLLOWER—tracks the input amount and forces the output level of this section to match. SPACE FC—sets the center frequency of the 4 pole digital high pass filter used in this section. This filter also changes phase as does the EXPAND one.

SPARKLE—There are several components to this module. They are: SPARKLE HPFC—This is a 2 pole high pass filter with a preboost which sets the lower frequency limit of this filter. Anything above this setting passes through the filter while anything below is discarded or stopped from passing. SPARKLE TUBE THRESH—sets the lower level at which the tube simulator begins working. As the input increases, so does the amount of the tube sound. The tube sound is adding harmonics, compression and a slight bit of distortion to the input sound. This amount increases slightly as the input level increases. SPARKLE TUBE BOOST—sets the final level of the output of this module. This is the effected signal only, without the original.

SUB BASS—this module takes the input signal and uses a low pass filter to set the upper frequency limit to preferably about 100 Hz. An octave divider occurs in the software that changes the input signal to lower by an octave (12 semi tones) and output to the only control in the interface, which is the level or the final amount. This is the effected signal only, without the original.

The above discussed modules are fed to a summing mixer which combines the audio. The levels going into the summing mixer are controlled by the various outputs of the modules listed above. As they all combine with the original signal, there is interaction in phase, time and frequencies that occur dynamically. These changes all combine to create a highly accurate sonic picture of a selected target area. This allows the operator to identify targets that would have been unseen without the aid of this process.

STEREO EXPANDER—Modern music has little to no stereo field due to the amount of audio compression or even data compression into a lower format (Mp3, AAC, etc.). The purpose of this soundfield expander is to make a wider stereo image (a simulated distance increase between the left and right audio) for the listener to enjoy. This works particularly well with headphones. An end user will be able to control an amount of the effect on the soundfield to their liking with this process. The conventional way to create an expanded stereo field is by using some type of delay, like chorus effect, reverb, or a simple delay on one side of the stereo audio. This creates an un realistic soundfield. Using these kinds of effects, either independently or combined, for the soundfield expansion creates very strong and very audible phase problems. Sometimes this type of effect can cause a ringing effect as a comb filter would. The Soundfield Expander doesn't exhibit these problems.

The Stereo Expander works in a dynamic fashion which almost entirely deletes these audible issues. The end result is a clear, highly defined soundfield expansion with a greater amount of intelligibility. This “audio expander” can be used as stand alone software if desired. It was designed and intended to be used in the smart phone App as an enhancement to the existing App. It is intended to expand the spatial properties of existing audio. This can be used for both digital and analog audio listening devices and playback units. The process starts by taking the incoming audio and sending it into a block that splits, processes and combines the stereo stream into several different versions that are fed into the Stereo Bus A. (Refer to FIG. 2 for detailed explanations.) Stereo Bus A goes into a Compare Block that adjusts the amplitude of the original and processed audio by averaging. One skilled in the art would appreciate that this is not a compressor/limiter type block. In one embodiment, there is a fixed ratio of 2.75 (Stereo Bus A) to 1 (Original Stereo Source) that operates in both positive and negative directions. The end result is an expanded stereo field that both expands and contracts as real audio does.

According to one embodiment, there will be a single “slider” or Stereo Amount that will adjust the mix of the audio from a zero to maximum amount with only a slight gain change in the overall amplitude. In addition, the amount could be driven by an envelope follower to create a dynamic soundfield that changes according to the setting of the envelope follower.

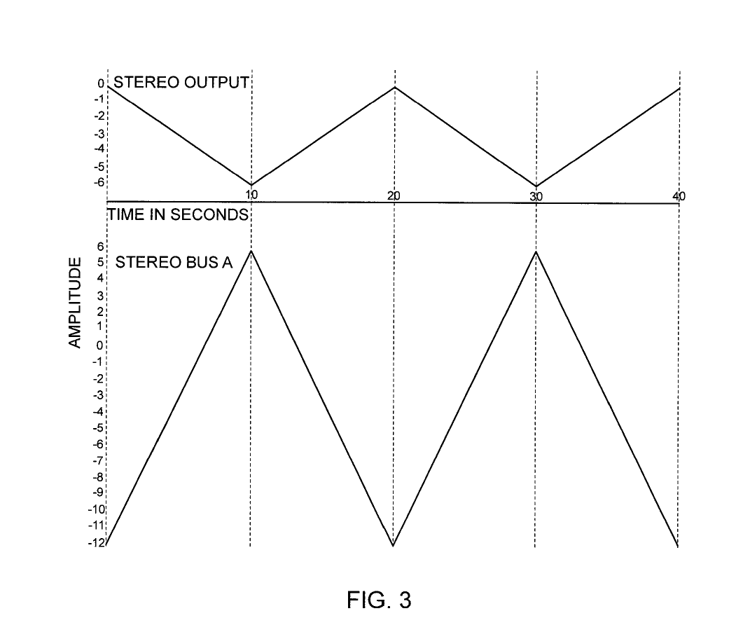

Referring to FIG. 2 which is a block diagram with signal flow. The STEREO SOURCE is mixed with the STEREO BUS A. Next it goes into the Compare Block where the output signal preferably stays very close to a constant amount. There are two separate tables for accomplishing this and are shown in FIG. 3. As the control slider (Stereo Amount) moves up and down, it changes the values in a corresponding amount to keep the level close to the same. It follows the dB amounts shown in FIG. 3. Blocks are: 1. L+R—the original left and right summed together and the output panned to center. 2. L−R—the original left and right with the right inverted and summed together. The output is panned to the left. 3. −R L—the original left and right with the left inverted and summed together. The output is panned to the right. 4.L+R—the original left and right summed together and panned to the center. This level is 6 dB lower than the original. 5. Filler Audio -the original left and right summed together and the output panned to center. There is a bandpass filter set for 55 Hz to 8.5 kHz. A delay is set for 30 ms for the left side only. All of the above blocks feed into Stereo Bus A. Their levels are shown in FIG. 1.6.

Compare Block—this block is depicted in FIG. 2 and explained above. Both the Stereo Bus A and Stereo Output levels are preferably controlled by a single control fader in the GUI. Their levels are shown in FIGS. 1 (−12 to +6 dB).

Referring to FIG. 3—this is an examplary representation of how the levels of Stereo Bus A and Stereo Output change according to each other. Even though there are two complete cycles show, there is no modulation source; this is only to show an example of turning the control fader fully up and down twice. This will ensure that the output doesn't have a great increase as the Stereo Bus A level is increased.

What is claimed is:

1. An audio enhancement technique comprising:
an audio source;
processing the audio source by the following modules:
a low pass filter with dynamic offset;
an envelope controlled bandpass filter;
a high pass filter; and
adding an amount of dynamic synthesized sub bass to the audio;
combining the processed audio signals in a summing mixer with the audio source to create an audio out signal;
sending audio out to a block that splits, processes and combines the stereo stream into several different versions that are fed into the Stereo Bus A;
Feeding Stereo Bus A output to a Compare Block that adjusts the amplitude of the original and processed audio by averaging;
Feeding the output from the compare block as an stereo output for use by user

2. The technique of claim 1, wherein the ratio of the Stereo Bus A output to the Original audio source is 2.75.
